(19) United States
(12) Patent Application Publication
(10) Pub. No.: US 2019/0250053 A1
(43) Pub. Date: Aug. 15, 2019

(54) Lanyard with stress indicator

(71) Applicant: Ty-Flot, Inc., Manchester, NH (US)

(72) Inventors: Darrell A. Moreau, Manchester, NH (US); Andre W. Moreau, Bedford, NH (US)

(21) Appl. No.: 15/892,782

(22) Filed: Feb. 9, 2018

(51) Int. Cl. G01L 5/04; A45F 5/02

(52) U.S. Cl. CPC G01L 5/047; A45F 2005/006; A45F 5/021

(57) ABSTRACT

A stretchable lanyard has a stressed lanyard indicator assembly. The stretchable lanyard includes a lanyard tool attaching end portion, a lanyard anchoring end portion, a stretchable lanyard body between the lanyard tool attaching end portion and the lanyard anchoring end portion, and the stressed lanyard indicator assembly connected to the stretchable lanyard to at least one of the lanyard tool attaching end portion and the lanyard anchoring end portion. The stressed lanyard indicator assembly extends over a portion of the stretchable lanyard body where the stress lanyard indicator assembly indicates when a falling tool arresting event with sufficient force has occurred.

### BACKGROUND OF THE INVENTION

### 1. Field of the Invention

The present invention relates generally to lanyards. Particularly, the present invention relates to stretchable lanyards.

### 2. Description of the Prior Art

Lanyards, tethers, hooks, and similar restraints are used to prevent accidental dropping of tools. These restraints are particularly useful in environments where a tool drop can cause substantial damage or harm to plant equipment, workers, or objects below a worker who accidentally drops a tool.

Window washers commonly work in locations high above a crowded street. Also, plumbers, electricians, and painters commonly are required to work on high level platforms or rigging when working on ceiling areas of a building, which again can be high above the floor of the building.

Plumbers and pipefitters are required to employ heavy wrenches in the performance of their work. Electricians are required to employ heavy screw drivers, and side-cutting pliers in the performance of their work. Painters, are required to employ scrapers, paint rollers, and sanding blocks in the performance of their work. The above-named tools and implements are representative only of an enormous variety of tools and implements used in various trades for various purposes. Such tools and implements usually are hand-held by the workmen, usually in the absence of a tether or leash that attaches the tool or implement either to a structure in the immediate vicinity of the workman, or, more commonly, to a tool belt worn by the workman when working in elevated locations.

If the workman is working in a confined or tight area, the chance of dropping the tool or hardware increases. The dropped tool or hardware can fall within or behind structures or roll underneath things. The workman must then stop what he is doing, and retrieve the tool or hardware, causing delay and inconvenience. Sometimes, the tool or hardware may be irretrievable. Sometimes the problem of dropping the tool or hardware is repeated for the same particular operation. If a workman is working at a high location, such as on a ladder or the like, and he drops a tool, he must climb down from the location to search and locate the dropped tool. Furthermore, a dropped tool from a high height can damage the tool, damage equipment and machinery it hits, and could cause bodily injury to other individuals below.

One method of tethering a tool includes clipping one end of a tether to an opening in the handle of a tool (e.g., an adjustable wrench) and to clip the other end of the tether to the worker's belt or to a nearby structure. When workers properly tether a tool in this way, accidental drops can be eliminated or substantially reduced. However, due to safety concerns and to practical design limitations, hand-held power tools are generally not specifically designed to be tethered. For example, the moving parts on rotary saws and drills potentially could get tangled with the tether, causing injury to a worker or severing the tether when the tool is dropped. Also, when compared to hand-held tools, the larger size of battery-powered power tools provides options for tethering that are not available with hand-held tools. For example, to tether a power tool, the user may tether the battery-powered power tool, such as by attaching a tether to an opening in the tool's frame, wrapping the tether around a handle, or other improvised approach. Cordless drills are an example of one power tool that lacks an opening to which a tether could be attached.

In recent years, there have been a plethora of tool lanyards devised and used. Most of the more recent tool lanyards have a stretchable quality such that if a tool is dropped, the tool tether stretches with resistance causing the dropped tool to slow its descent and prevent the full impact of arresting the dropped tool to the workman since the anchoring end of the tether is usually connected to workman's harness or tool belt. In other words, the stretchable tool lanyard lessens the arresting force of the dropped tool that is imparted to the anchoring end of the tool lanyard.

### SUMMARY OF THE INVENTION

Although the development of the stretchable lanyard has further lessened the number of injuries and damaged tools caused when a tool is accidentally or inadvertently dropped, each accidental or inadvertent drop of a tethered hand tool weakens the tether. Unfortunately, there is no way to tell by visually inspecting a stretchable tool lanyard whether the next accidental or inadvertent drop of the hand tool will cause the tether to break and thereby release the tool to continue its descent.

It is an object of the present invention to provide a stretchable lanyard that indicates whether the stretchable lanyard should be replaced.

The present invention achieves these and other objectives by providing a stretchable lanyard with a stressed lanyard indicator assembly. In one embodiment, a stretchable lanyard for arresting a falling hand tool attached to the stretchable lanyard includes a lanyard tool attaching end portion, a lanyard anchoring end portion, a stretchable lanyard body disposed between the lanyard tool attaching end portion and the lanyard anchoring end portion, and a stressed lanyard indicator assembly connected to the stretchable lanyard to at least one of the lanyard tool attaching end portion and the lanyard anchoring end portion. In other words, the stressed lanyard indicator assembly can be connected to either end of the stretchable lanyard body or a stressed lanyard indicator assembly may be connected on each end of the stretchable lanyard body. The stressed lanyard indicator assembly extends over a portion of the stretchable lanyard body where the stress lanyard indicator assembly indicates when a falling tool arresting event has occurred with sufficient force to make continued use of the stretchable lanyard unsafe.

In one embodiment of the present invention, the stressed lanyard indicator assembly includes at least one stress indicium that, when a falling tool arresting event with sufficient force has occurred, the at least one stress indicium changes from one of (1) a non-triggered position to a triggered position or (2) a non-visual position to a visual position. It is contemplated that the at least one stress indicium may be 1, 2, 3, or more stress indicia. It is further contemplated that the number pg stress indicia that have changed from a non-triggered position to a triggered position or the number of stress indicia that are visible may also indicate the degree of stress that the stretchable lanyard has experienced, thus providing a sliding scale indication of the remaining usable life of the stretchable lanyard.

In another embodiment of the present invention, the stressed lanyard indicator assembly further includes a predefined length of outer tubing surrounding a portion of the stretchable lanyard body. The predefined length of outer tubing is fixed on one end to one of a respective one of the lanyard tool attaching end portion and the lanyard anchoring end portion. On an opposite end, not fixed to the stretchable lanyard body wherein the at least one stress indicium is between the outer tubing and the portion of the stretchable lanyard body before a falling tool arresting event has occurred.

In another embodiment of the present invention, the at least one stress indicium is one of (1) a mark disposed on or embedded into the stretchable lanyard body, (2) a predefined length of shrink tubing surrounding and fixed to a portion of the stretchable lanyard body, and (3) a biasing indicator strap where the biasing indicator strap is fixed on one end between a predefined length of shrink tubing surrounding the stretchable lanyard body and fixed to a portion of the stretchable lanyard body and not fixed at an opposite end where the biasing indicator strap is folded upon itself before a falling tool arresting event with sufficient force has occurred and biased away from itself after a falling tool arresting event with sufficient force has occurred.

In one embodiment of the present invention, the at least one stress indicium is a mark disposed on or embedded into an indicator strap where the indicator strap is fixed on one end to a predefined length of shrink tubing surrounding and fixed to a portion of the stretchable lanyard body adjacent to but spaced from the respective one of the lanyard tool attaching end portion and the lanyard anchoring end portion. The indicator strap is fixed on an opposite end to a corresponding one of the lanyard tool attaching end portion and the lanyard anchor attaching end portion where the mark is captured by the shrink tubing before a falling tool event with sufficient force has occurred and released by the shrink tubing after a falling tool event with sufficient force has occurred.

In another embodiment, the predefined length of shrink tubing is an adhesive shrink tubing.

In one embodiment, the predefined length of shrink tubing is one of opaque, translucent or transparent.

In another embodiment, the outer tubing is one of opaque, translucent or transparent.

In one embodiment, a method is disclosed for determining when a stretchable lanyard has experienced a falling tool event with sufficient force has occurred. The method includes obtaining a stretchable lanyard having a stressed lanyard indicator assembly connected to the stretchable lanyard adjacent to at least one of a lanyard tool attaching end portion or a lanyard anchoring end portion, looking at the stressed lanyard indicator assembly, and determining whether at least one stress indicium has changed from one of (1) a non-triggered position to a triggered position or (2) a non-visual position to a visual position where the at least one stress indicium indicates whether a falling tool arresting event with sufficient force has occurred.

In another embodiment of the present invention, a method of making a stretchable lanyard with a stress indicator is disclosed. The method includes obtaining a stretchable lanyard having a lanyard tool attaching end portion, a lanyard anchoring end portion and a stretchable lanyard body disposed between the lanyard tool attaching end portion and the lanyard anchoring end portion, and attaching a stressed lanyard indicator assembly adjacent to at least one of the lanyard tool attaching end portion or the lanyard anchoring end portion and extends over a portion of the stretchable lanyard body where the stressed lanyard indicator assembly indicates when a falling tool arresting event with sufficient force has occurred.

In one embodiment, the method includes providing at least one stress indicium in the stressed lanyard indicator assembly that changes when a falling tool arresting event with sufficient force has occurred from one of (1) a non-triggered position to a triggered position or (2) a non-visual position to a visual position.

In another embodiment, the method includes providing a predefined length of outer tubing and surrounding a portion of the stretchable lanyard body where the predefined length of outer tubing is fixed on one end to one of a respective one of the lanyard tool attaching end portion and the lanyard anchoring end portion and, on an opposite end, not fixed to the stretchable lanyard body where the at least one stress indicium is between the outer tubing and the portion of the stretchable lanyard body before a falling tool arresting event with sufficient force has occurred.

In a further embodiment, the method includes selecting the at least one stress indicium from (1) a mark disposed on or embedded into the stretchable lanyard body, (2) a predefined length of shrink tubing surrounding and fixed to a portion of the stretchable lanyard body and (3) a biasing indicator strap where the biasing indicator strap is fixed on one end between a predefined length of shrink tubing surrounding and fixed to a portion of the stretchable lanyard body and not fixed at an opposite end where the biasing indicator strap is folded upon itself before a falling tool arresting event with sufficient force has occurred and biased away from itself after a falling tool arresting event with sufficient force has occurred.

In one embodiment, the method includes selecting the at least one stress indicium that is a mark disposed on or embedded into an indicator strap where the indicator strap is fixed on one end to a predefined length of shrink tubing surrounding and fixed to a portion of the stretchable lanyard body adjacent to but spaced from the respective one of the lanyard tool attaching end portion and the lanyard anchoring end portion and, on an opposite end, to a corresponding one of the lanyard tool attaching end portion and the lanyard anchor attaching end portion where the mark is captured by the shrink tubing before a falling tool event with sufficient force has occurred and released by the shrink tubing after a falling tool event with sufficient force has occurred.

### BRIEF DESCRIPTION OF THE DRAWINGS

FIG. 1 is a perspective view of one embodiment of the present invention showing a stretchable lanyard and a stressed lanyard indicator assembly that is an indicator strap with at least one indicium.

FIG. 1A is an enlarged, perspective view of the stressed lanyard indicator assembly of FIG. 1 showing the at least one indicium.

FIG. 1B is an enlarged, side elevation view of the stressed lanyard indicator assembly of FIG. 1.

FIG. 2 is a perspective view of the embodiment of FIG. 1 showing a stretchable lanyard and a stressed lanyard indicator assembly that is an indicator strap with at least one indicium after a falling tool arresting event with sufficient force having occurred.

FIG. 2A is an enlarged, perspective view of the stressed lanyard indicator assembly of FIG. 2 showing the at least one indicium.

FIG. 2B is an enlarged, side elevation view of the stressed lanyard indicator assembly of FIG. 2.

FIG. 3 is a perspective view of another embodiment of the present invention showing a stretchable lanyard and a stressed lanyard indicator assembly that is a folded indicator strap.

FIG. 3A is an enlarged, perspective view of the stressed lanyard indicator assembly of FIG. 3 showing the folded indicator strap.

FIG. 4 is a perspective view of the embodiment of FIG. 3 showing a stretchable lanyard and a stressed lanyard indicator assembly that is the folded indicator strap in an unfolded position after a falling tool arresting event with sufficient force having occurred.

FIG. 4A is an enlarged, perspective view of the stressed lanyard indicator assembly of FIG. 4 showing the unfolded indicator strap.

FIG. 4B is an enlarged, side elevation view of the stressed lanyard indicator assembly of FIG. 4.

FIG. 5 is a perspective view of another embodiment of the present invention showing a stretchable lanyard and a stressed lanyard indicator assembly where the at least one indicium is a piece of shrink tubing fixed to the stretchable lanyard body and positioned within an outer tubing.

FIG. 5A is an enlarged, perspective view of the stressed lanyard indicator assembly of FIG. 5 showing the piece of shrink tubing as the at least one indicium.

FIG. 6 is a perspective view of the embodiment of FIG. 5 showing a stretchable lanyard and a stressed lanyard indicator assembly where the at least one indicium is the piece of shrink tubing outside of the outer tubing after a falling tool arresting event with sufficient force has occurred.

FIG. 6A is an enlarged, perspective view of the stressed lanyard indicator assembly of FIG. 6 showing the exposed piece of shrink tubing.

FIG. 6B is an enlarged, side elevation view of the stressed lanyard indicator assembly of FIG. 6.

FIG. 7 is a perspective view of another embodiment of the present invention showing a stretchable lanyard and a stressed lanyard indicator assembly where the at least one indicium is a mark fixed to the stretchable lanyard body and positioned within an outer tubing.

FIG. 7A is an enlarged, perspective view of the stressed lanyard indicator assembly of FIG. 7 showing the mark fixed to the stretchable lanyard body as the at least one indicium.

FIG. 7B is an enlarged, side elevation view of the stressed lanyard indicator assembly of FIG. 7.

FIG. 8 is a perspective view of the embodiment of FIG. 7 showing a stretchable lanyard and a stressed lanyard indicator assembly where the at least one indicium is the mark fixed to the stretchable lanyard body and is located outside of the outer tubing after a falling tool arresting event with sufficient force has occurred.

FIG. 8A is an enlarged, perspective view of the stressed lanyard indicator assembly of FIG. 8 showing the mark that is the at least one indicium.

FIG. 8B is an enlarged, side elevation view of the stressed lanyard indicator assembly of FIG. 8.

### DETAILED DESCRIPTION OF THE INVENTION

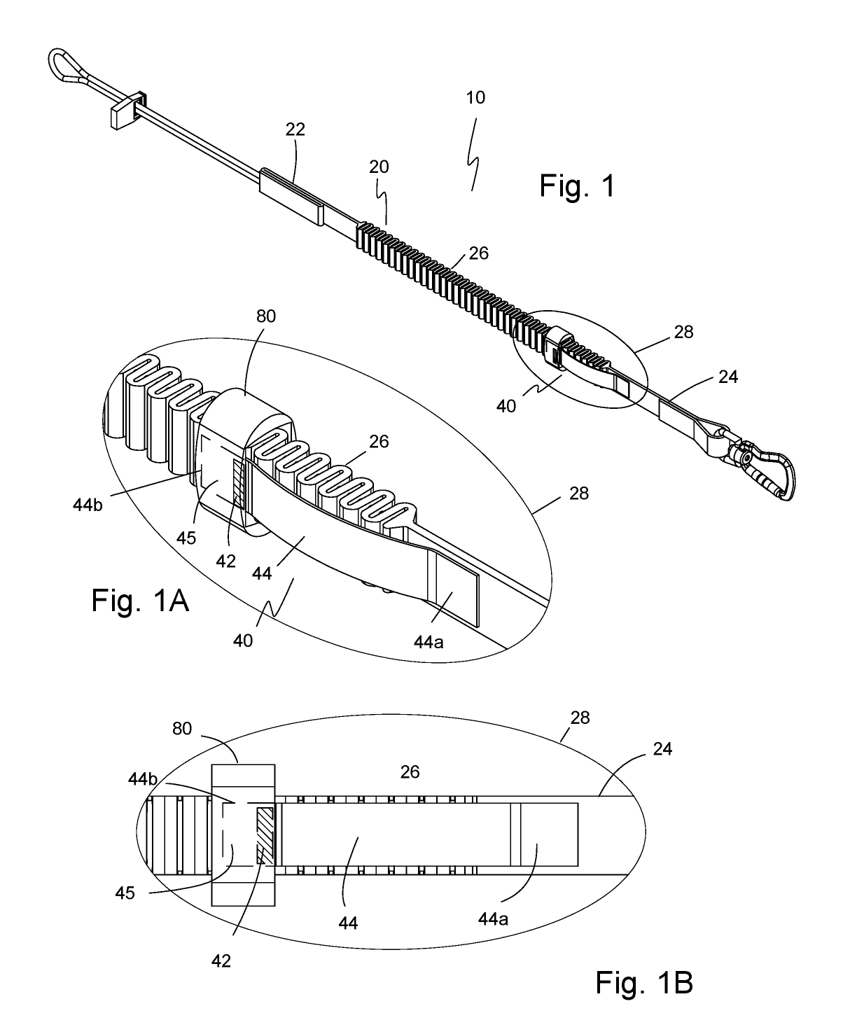

Various embodiments of the present invention are illustrated in FIGS. 1-8. FIG. 1 shows one embodiment of a tool lanyard 10 of the present invention. Tool lanyard 10 includes a stretchable lanyard 20 and a stressed lanyard indicator assembly 40. Stretchable lanyard 20 includes a lanyard tool attaching end portion 22, a lanyard anchoring end portion 24 and a stretchable lanyard body 26. Stretchable lanyard body 26 has a polymer core (that is a sacrificial core) that has stretch and resilient properties and a typical sleeve of a woven polyester or similar material that is bunched around the core to permit stretching from a relaxed state to an extended state and return to a modified relaxed state, all as is well known to those skilled in the art. The polymer core is typically made of a polyester fiber and is a partially oriented yarn. The above-described stretchable lanyard is also known as a shock-absorbing tether where the polymer core only stretches a limited amount but lengthens as each drop occurs. The advantage is that the arresting force at the stop of the descent of the tool is minimized where the polymer core prevents a bounce-up or recoil of the tool compared to standard bungee-type cords that exhibit a recoil of the tool. However, other stretchable lanyards known as bungee cords having a nylon shell or a shell that is stretchable with a core that is not a polymer core also works in the present invention. Although the stretchable lanyard body 26 works as intended, when a tool is inadvertently or accidentally dropped, the sudden fall arrest of the tool when the stretchable lanyard 20 reaches its furthest extension can cause damage to the polymer core. The damage typically results in a stretching capability that is less than that for a stretchable lanyard 20 that has not experienced a falling tool arresting event.

All stretchable lanyards 20 have a rating based on the maximum weight of a tool that may be attached to such a lanyard. This can range from 1 to 5 pounds or more. This is important so that an accidental or inadvertent drop of an attached tool does not impart a force greater than the rating of the stretchable lanyard 20. For example, if a tool is attached to a stretchable lanyard 20 that is heavier than the rating for the stretchable lanyard 20, it is possible that an inadvertent drop could break the lanyard. Even when the tool weight is within the rating of the stretchable lanyard 20, a single drop may cause the stretchable lanyard to sustain unnoticed damage such that the weight rating for the stretchable lanyard 20 is no longer valid. In other words, the weight rating for the stretchable lanyard 20 may now be only 1 pound instead of the original rating of 4 or 5 pounds. This increases the potential of the stretchable lanyard 20 to break the next time an inadvertent or accidental drop occurs.

The stressed lanyard indicator assembly 40 of the present invention is designed to indicate to a user when a stretchable lanyard 20 has sustained sufficient damage after a falling tool arresting event has occurred that compromises the weight rating of the stretchable lanyard 20.

In a first embodiment for the present invention, the stressed lanyard indicator assembly 40 is shown better detail in FIGS. 1A and 1B. In this embodiment, stressed lanyard indicator assembly 40 includes an indicator strap 44 having a first strap end portion 44a that is securely attached to one of the lanyard tool attaching end portion 22 of the stretchable lanyard 20 or the lanyard anchoring end portion 24 and a second strap end portion 44b with at least one stress indicium formed on or into a second strap end portion surface 45. Second strap end portion 44b is partially retained against stretchable lanyard body 26 by a piece of shrink tubing 80. As can be seen in FIG. 1A, indicator strap 44 has excess strap bowing away from stretchable lanyard body 26 so that indicator strap 44 has sufficient play during normal use of stretchable lanyard 26 not to indicate that a falling tool arresting event has occurred if the force was not sufficient to so indicate. In this embodiment, the at least one stress indicium 42 is underneath the shrink tubing 80 and cannot be visually seen by the user.

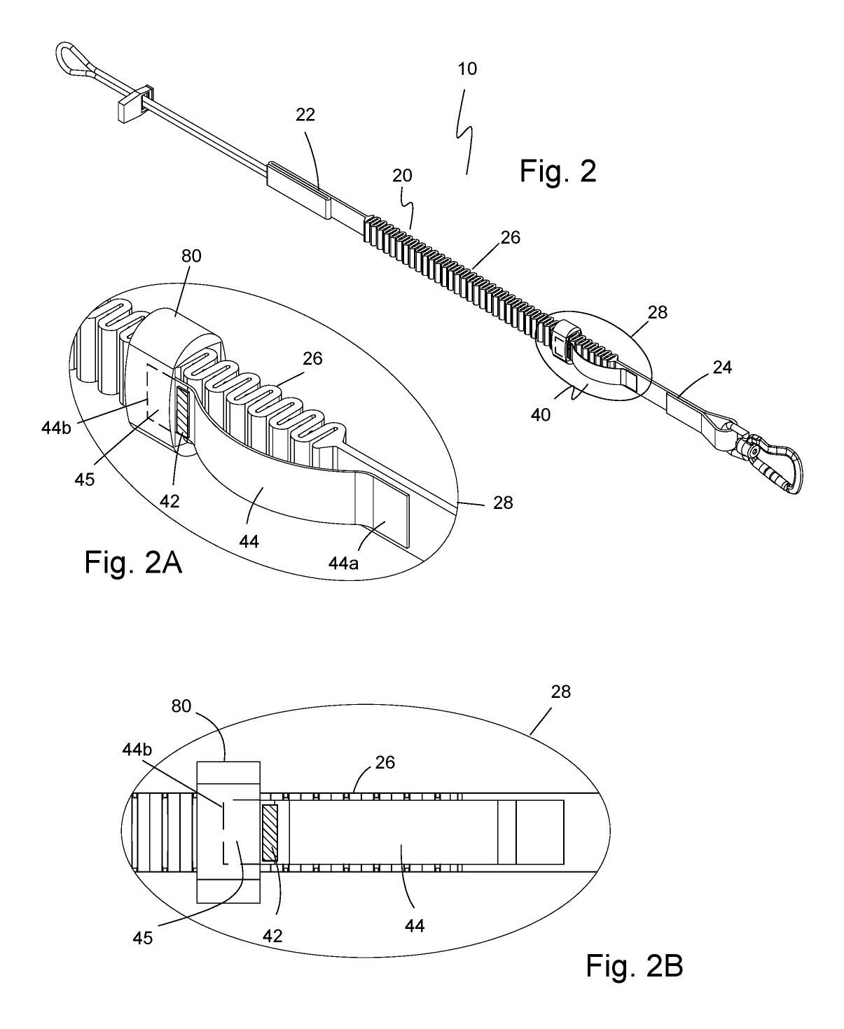

FIGS. 2, 2A and 2B illustrate the embodiment of the present invention in FIGS. 1, 1A and 1B after a falling tool arresting event with sufficient force has occurred. As can be seen in the Figures, the at least one stress indicium 42 is now visible. When a falling tool arresting event occurs, stretchable lanyard 20 has endured a full stretching of stretchable lanyard body 26 with a sudden stop as it reaches is maximum extension. The force of the stop caused by the weight of the tool attached to the lanyard tool attaching end portion 22 may cause second strap end portion 44b to partially pull out from underneath shrink tubing 80 exposing the at least one stress indicium. Strap end portion 44b may not always partially pull out from underneath shrink tubing 80. This may occur when the weight of the tool is far below the weight rating of the stretchable lanyard 20 such that stretchable lanyard 20 does not incur sufficient dropped tool forces to damage stretchable lanyard 20. This may also occur when the weight of the tool is within the weight rating of the tool such that stretchable lanyard 20 may be able to experience multiple drops before the at least one stress indicium is exposed. The advantage of the stressed lanyard indicator assembly 40 of the present invention is to provide to a user an indication of when the stretchable lanyard 20 may no longer be safe to use. In other words, an indication that the next inadvertent or accidental tool drop may cause the tool to break free from the stretchable lanyard causing a dangerous situation.

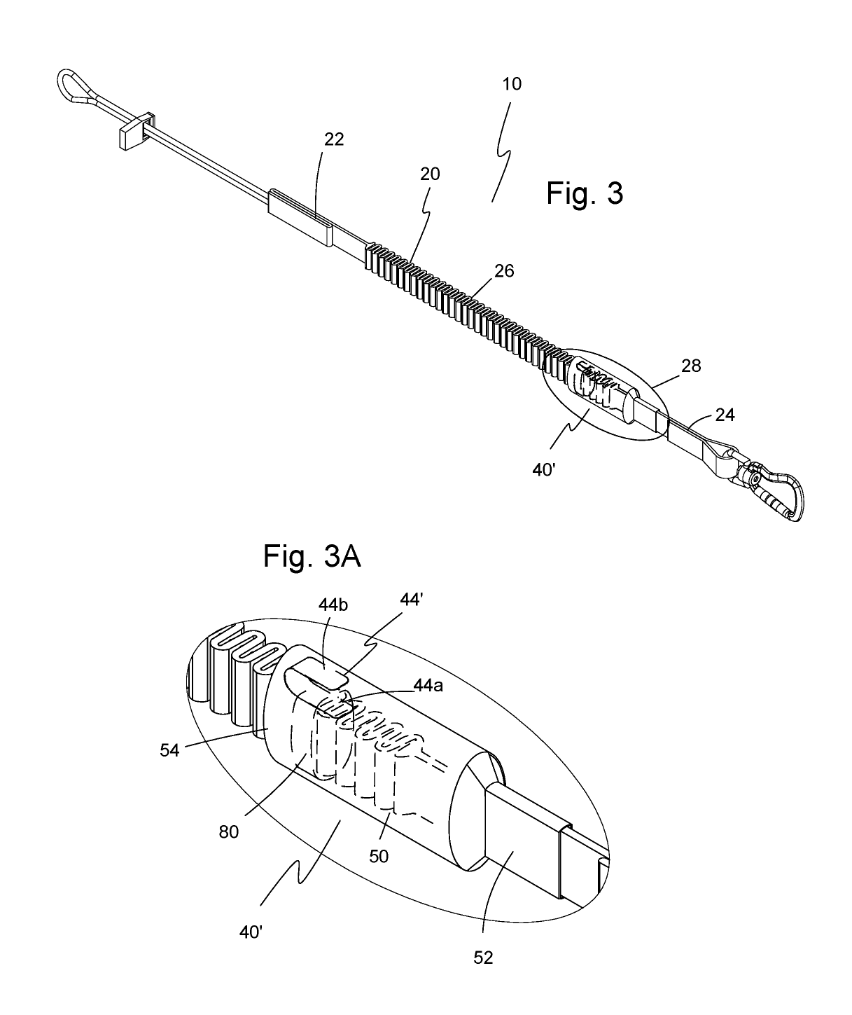

Turning now to FIGS. 3 and 3A, there is illustrated another embodiment of the present invention. In this embodiment, a stressed lanyard indicator assembly 40′ includes an outer tubing 50 having a first tubing end portion 52 and a second tubing end portion 54. First tubing end portion 52 is sized to be snug around one of the lanyard anchoring end portion 24 or the lanyard tool attaching end portion 22. Second tubing end portion 54 is open and surrounds a portion of stretchable lanyard body 26. Second tubing end portion 54 is sized to allow the portion of stretchable lanyard body 26 within outer tubing 50 to move in a linear direction longitudinally within outer tubing 50. In this embodiment, the at least one stress indicium is a bendable, resilient, biasing indicator strap 44′. Biasing indicator strap 44′ has a fixed or secured strap end portion 44a and a free strap end portion 44b, meaning that free strap end portion 44b is not fixed or secured to stretchable lanyard body 26. Fixed strap end portion 44a is secured to stretchable lanyard body 26 by a piece of shrink tubing 80. Biasing indicator strap 44′ is folded on itself such that free strap end portion 44b is held in the folded position by outer tubing 50. Biasing indicator strap 44′ is positioned on stretchable lanyard body 26 within outer tubing 50 so that during normal use of stretchable lanyard 20, biasing indicator strap 44′ does not stretch out of outer tubing 50 such that free strap end portion 44b of biasing indicator strap 44′ is released or allowed to unfold.

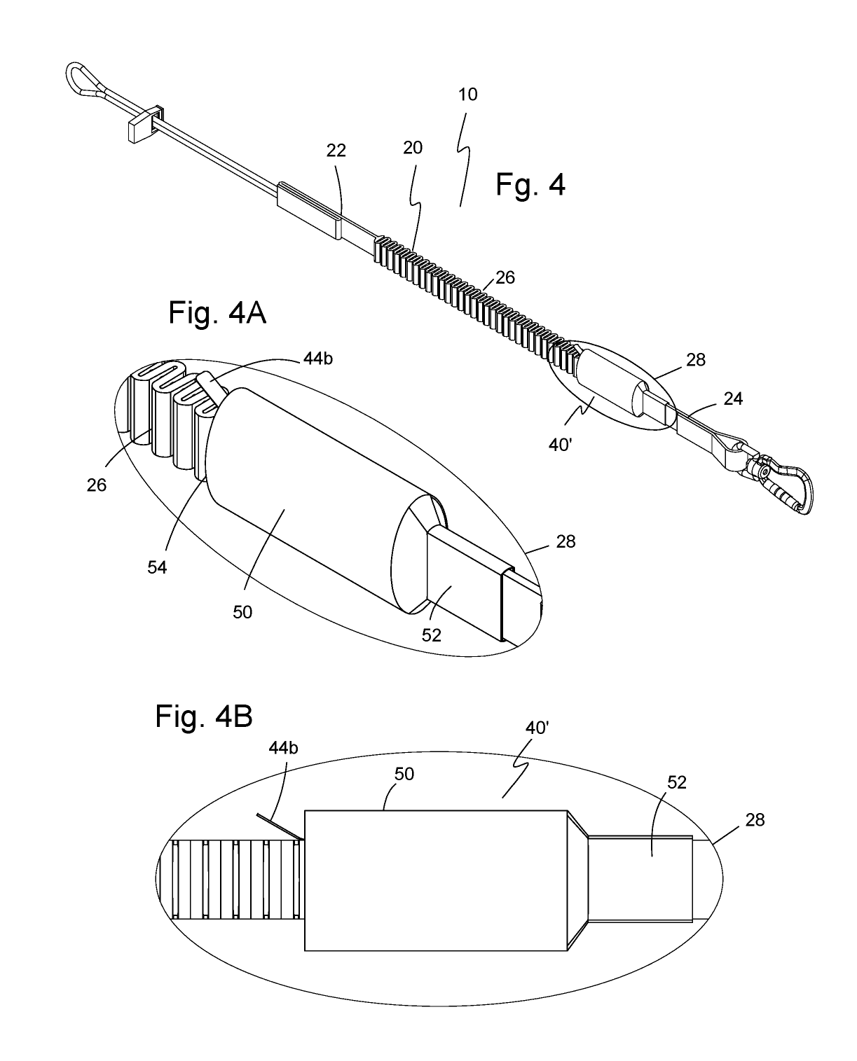

FIGS. 4, 4A and 4B illustrate the embodiment of the present invention in FIGS. 3 and 3A after a falling tool arresting event with sufficient force has occurred. As can be seen in the Figures, the at least one stress indicium 42′ is now visible. In this embodiment, the at least one stress indicium 42′ is synonymous with free strap end portion 44b. It is contemplated that free strap end portion 44b may optionally include a separate stress indicium 42′ on the surface 44b′ of free strap end portion 44b. When a falling tool arresting event occurs, stretchable lanyard 20 has endured a full stretching of stretchable lanyard body 26 with a sudden stop as it reaches is maximum extension. The force of the stop caused by the weight of the tool attached to the lanyard tool attaching end portion 22 may cause free strap end portion 44b to pull out from within outer tubing 50 allowing free strap end portion 44b to unfold exposing the at least one stress indicium. Notwithstanding that after the weight of the tool is removed from stretchable lanyard 20 and stretchable lanyard body 26 returns towards a relaxed state, free strap end portion 44b remains exposed and sticking out of outer tubing 50 indicating a falling tool event having sufficient force to expose the at least one indicium 42′ has occurred. Strap end portion 44b may not always partially pull out from underneath outer tubing 50. This may occur when the weight of the tool is far below the weight rating of the stretchable lanyard 20 such that stretchable lanyard 20 does not incur sufficient dropped tool forces to damage stretchable lanyard 20. Other reasons and/or situations could exist such as those described for FIGS. 2, 2A and 2B.

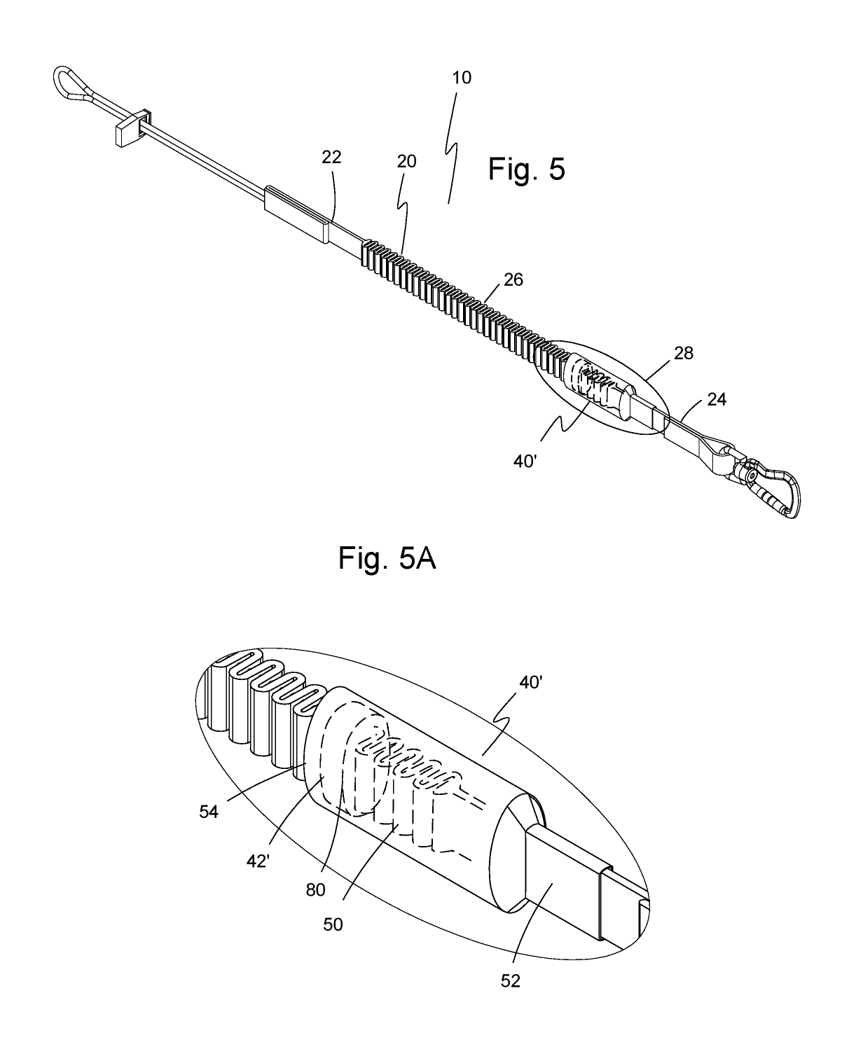

Turning now to FIGS. 5 and 5A, there is illustrated another embodiment of the present invention. In this embodiment, a stressed lanyard indicator assembly 40′ includes outer tubing 50 having first tubing end portion 52 and second tubing end portion 54. As described previously, first tubing end portion 52 is sized to be snug around one of the lanyard anchoring end portion 24 or the lanyard tool attaching end portion 22. Second tubing end portion 54 is open and surrounds a portion of stretchable lanyard body 26. Second tubing end portion 54 is sized to allow the portion of stretchable lanyard body 26 within outer tubing 50 to move in a linear direction longitudinally within outer tubing 50. In this embodiment, the at least one stress indicium 42′ is a piece of shrink tubing 80 secured around a portion of stretchable lanyard body 26. It is understood that the at least one stress indicium 42′ may be a predefined amount of tape rolled around stretchable lanyard body 26, which tape may be electrical tape, duct tape, amalgamated tape, and the like. Although other surrounding structures may be used as the at least one stress indicium 42′, such structures must be sufficiently secured to the outer layer of stretchable lanyard body 26 so that they do not move from their location on the outer layer of stretchable lanyard body 26 but are not so secured so as to interfere with the stretch and resilient properties of the polymer core of stretchable lanyard body 26. Shrink tubing 80 in this embodiment acts as the at least one stress indicium 42′. The cross-sectional area or cross-section of shrink tubing 80 is sufficiently close to the cross-sectional area or cross-section of outer tubing 50 such that once the at least one stress indicium 42′ in this embodiment is pulled out of outer tubing 50, the ratio of the cross-sections are such that the at least one stress indicium 42′ cannot, by the force of stretchable lanyard body 26 returning to the relaxed state, pull the at least one stress indicium 42′ back into outer tubing 50. The cross-sectional shapes of the at least one stress indicium 42′ and outer tubing 50 may be circular, elliptical, square, or rectangular. The at least one stress indicium 42′ is positioned on stretchable lanyard body 26 within outer tubing 50 so that, during normal use of stretchable lanyard 20, the at least one stress indicium 42′ (in this embodiment, shrink tubing 80) does not exit from outer tubing 50 such that the at least one stress indicium 42′ is not completely pulled out of outer tubing 50. It is contemplated that the shrink tubing outer surface 80a (or other material used for the same purpose as the case may be) may optionally include a separate stress indicium.

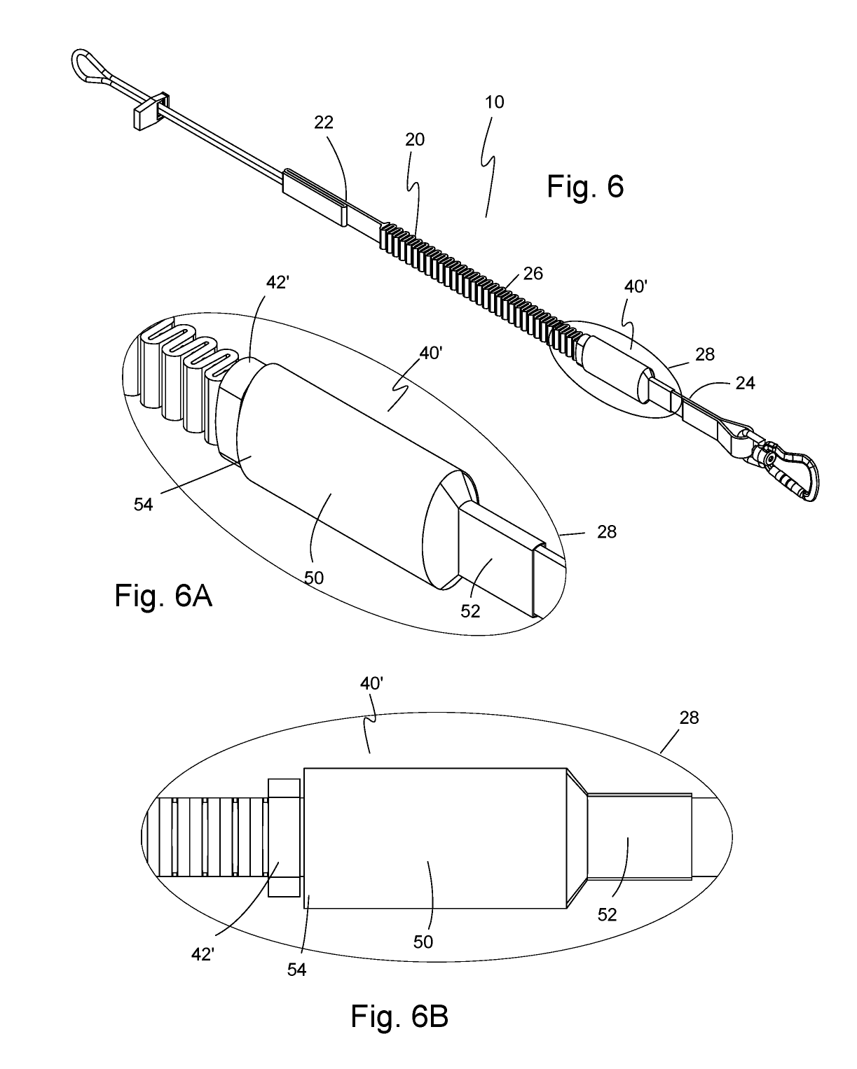

FIGS. 6, 6A and 6B illustrate the embodiment of the present invention in FIGS. 5 and 5A after a falling tool arresting event with sufficient force has occurred. As can be seen in the Figures, the at least one stress indicium 42′ is now visible. In this embodiment, the at least one stress indicium 42′ is synonymous with shrink tubing 80. When a falling tool arresting event occurs, stretchable lanyard 20 has endured a full stretching of stretchable lanyard body 26 with a sudden stop as it reaches is maximum extension. The force of the stop caused by the weight of the tool attached to the lanyard tool attaching end portion 22 may cause shrink tubing 80 (i.e. stress indicium 42′) to pull out completely from within outer tubing 50. Notwithstanding that after the weight of the tool is removed from stretchable lanyard 20 and stretchable lanyard body 26 returns towards a relaxed state, shrink tubing 80 remains exposed outside of outer tubing 50 due to the ratio of the outer cross-section of shrink tubing 80 and the inner cross-section of outer tubing 50 indicating a falling tool event having sufficient force to expose the at least one indicium 42′ has occurred. Shrink tubing 80 may not always pull out completely from within outer tubing 50. This may occur when the weight of the tool is far below the weight rating of the stretchable lanyard 20 such that stretchable lanyard 20 does not incur sufficient dropped tool forces to damage stretchable lanyard 20. Other reasons and/or situations could exist such as those described for FIGS. 2, 2A and 2B.

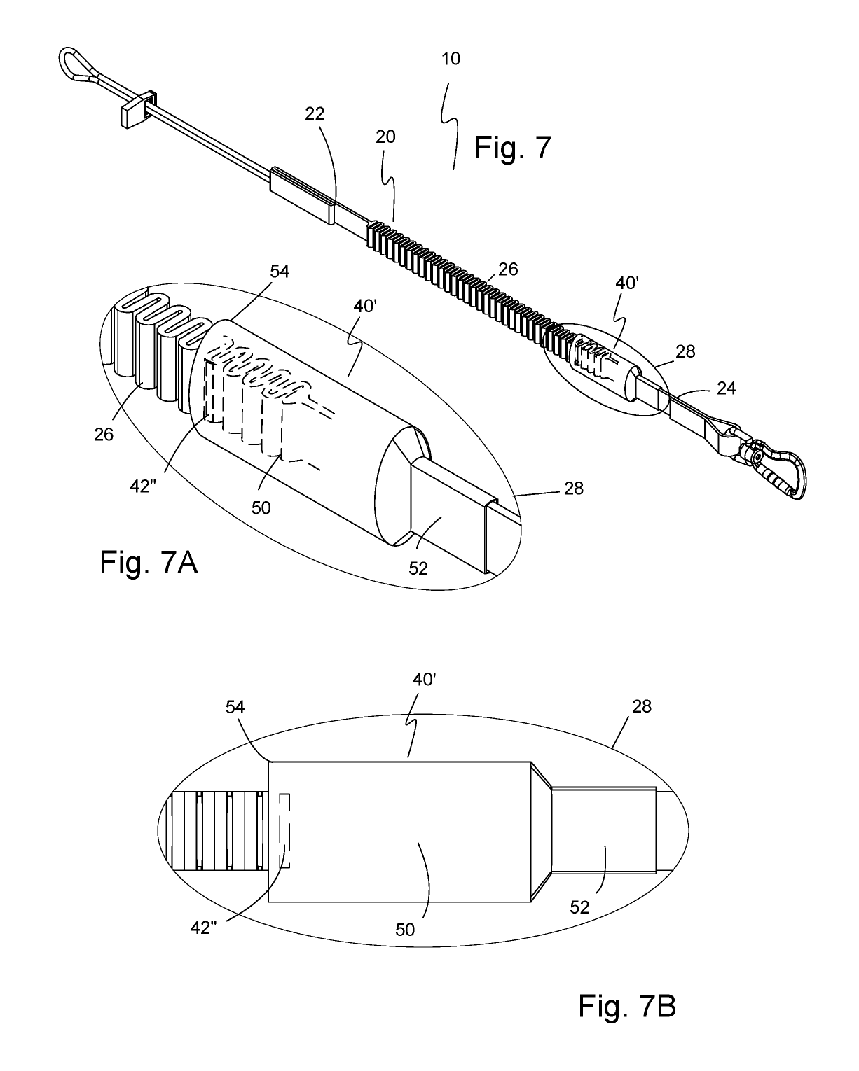

Turning now to FIGS. 7, 7A and 7B, there is illustrated another embodiment of the present invention. In this embodiment, a stressed lanyard indicator assembly 40′ includes outer tubing 50 having first tubing end portion 52 and second tubing end portion 54. As described previously, first tubing end portion 52 is sized to be snug around one of the lanyard anchoring end portion 24 or the lanyard tool attaching end portion 22. Second tubing end portion 54 is open and surrounds a portion of stretchable lanyard body 26. Second tubing end portion 54 is sized to be sufficiently snug around stretchable lanyard body 26 so that the portion of stretchable lanyard body captured within second tubing end portion 54 during normal use of stretchable lanyard 20 does not pull out of outer tubing 50. In this embodiment, the at least one stress indicium 42″ is a mark disposed on or embedded into the outer surface 26a of stretchable lanyard body 26. It is understood that the at least one stress indicium may be paint, ink or other coating on outer surface 26a or may be other material intertwined or interweaved into the outer surface 26a. The mark in this embodiment acts as the at least one stress indicium 42″. The snugness of second tubing end portion 54 is sufficiently tight such that once the at least one stress indicium in this embodiment is pulled out of outer tubing 50, the snugness is such that the at least one stress indicium 42″ cannot, by the force of stretchable lanyard body 26 returning to the relaxed state, pull the at least one stress indicium 42″ back into outer tubing 50. The at least one stress indicium 42″ is positioned on stretchable lanyard body 26 within outer tubing 50 so that, during normal use of stretchable lanyard 20, at least one stress indicium 42″ (in this embodiment, a painted mark) does not stretch out of outer tubing 50 such that the at least one stress indicium 42″ is not completely pulled out of outer tubing 50.

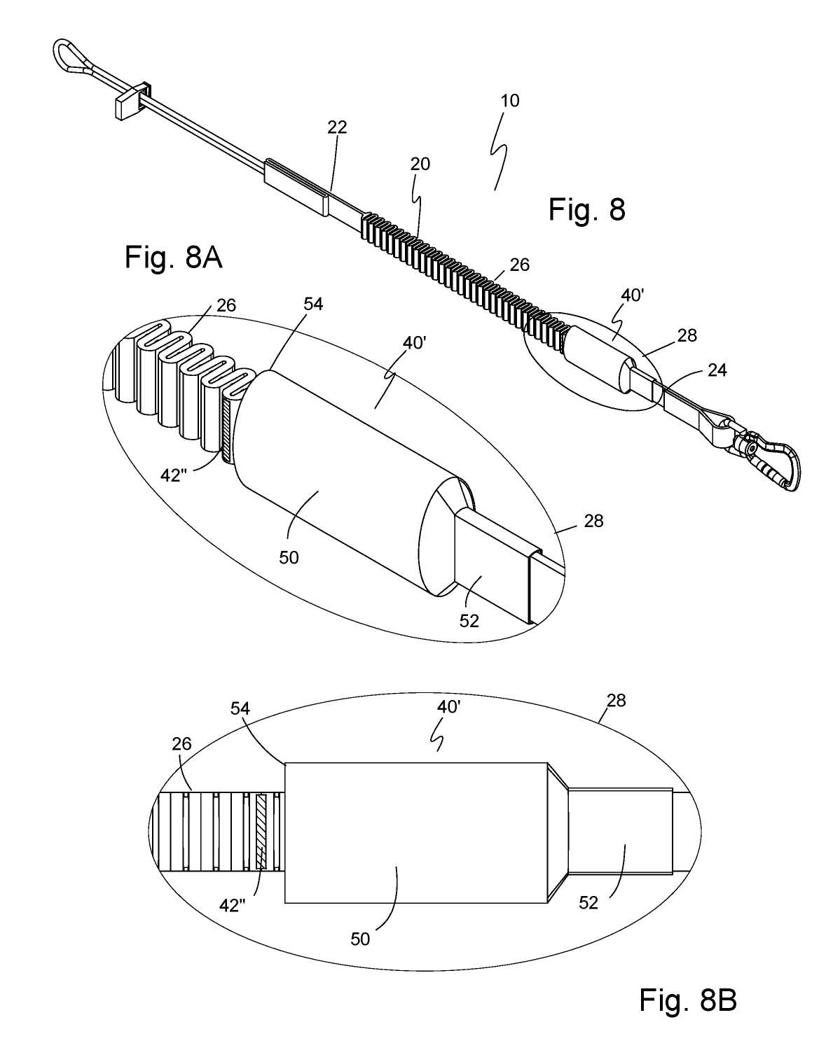

FIGS. 8, 8A and 8B illustrate the embodiment of the present invention in FIGS. 7, 7A and 7B after a falling tool arresting event with sufficient force has occurred. As can be seen in the Figures, the at least one stress indicium 42″ is now visible. In this embodiment, the at least one stress indicium 42″ is synonymous with a painted mark on surface 26a of stretchable lanyard body 26. When a falling tool arresting event occurs, stretchable lanyard 20 has endured a full stretching of stretchable lanyard body 26 with a sudden stop as it reaches is maximum extension. The force of the stop caused by the weight of the tool attached to the lanyard tool attaching end portion 22 may cause the painted mark (i.e. stress indicium 42″) to pull out completely from within outer tubing 50. Notwithstanding that after the weight of the tool is removed from stretchable lanyard 20 and stretchable lanyard body 26 returns towards a relaxed state, the at least one stress indicium 42″ remains exposed outside of outer tubing 50 due to the snugness ratio of the outer cross-section of stretchable lanyard body and the inner cross-section of outer tubing 50 indicating a falling tool event having sufficient force to expose the at least one indicium 42″ has occurred. The at least one stress indicium 42″ may not always pull out completely from within outer tubing 50. This may occur when the weight of the tool is far below the weight rating of the stretchable lanyard 20 such that stretchable lanyard 20 does not incur sufficient dropped tool forces to damage stretchable lanyard 20. Other reasons and/or situations could exist such as those described for FIGS. 2, 2A and 2B.

The major advantage of the present invention is the ability for a user to determine whether a stretchable lanyard is still safe to use. It is the stressed lanyard indicator assembly of the present invention that takes the guess work out of whether a stretchable lanyard will stop a falling tool without breaking the lanyard. When the stress indicium of the stressed lanyard indicator assembly appears on the lanyard, it is an indication that the stretchable lanyard is no longer safe to use. No other stretchable lanyard provides such an advantage.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A stretchable lanyard for arresting a falling hand tool attached to the stretchable lanyard, the stretchable lanyard comprising:
a lanyard tool attaching end portion;
a lanyard anchoring end portion;
a stretchable lanyard body disposed between the lanyard tool attaching end portion and the lanyard anchoring end portion; and
a stressed lanyard indicator assembly connected to the stretchable lanyard adjacent to at least one of the lanyard tool attaching end portion and the lanyard anchoring end portion and extends over a portion of the stretchable lanyard body wherein the stressed lanyard indicator assembly indicates when a falling tool arresting event with sufficient force has occurred.

2. The stretchable lanyard of claim 1 wherein the stressed lanyard indicator assembly includes at least one stress indicium that, when a falling tool arresting event with sufficient force has occurred, changes from one of (1) a non-triggered position to a triggered position or (2) a non-visual position to a visual position.

3. The stretchable lanyard of claim 2 wherein the stressed lanyard indicator assembly further includes a predefined length of outer tubing surrounding a portion of the stretchable lanyard body wherein the predefined length of outer tubing is fixed on one end to one of a respective one of the lanyard tool attaching end portion and the lanyard anchoring end portion and, on an opposite end, not fixed to the stretchable lanyard body wherein the at least one stress indicium is between the outer tubing and the portion of the stretchable lanyard body before a falling tool arresting event with sufficient force has occurred.

4. The stretchable lanyard of claim 3 wherein the at least one stress indicium is one of (1) a mark disposed on or embedded into the stretchable lanyard body, (2) a predefined length of shrink tubing surrounding and fixed to a portion of the stretchable lanyard body, and (3) a biasing indicator strap wherein the biasing indicator strap is fixed on one end between a predefined length of shrink tubing surrounding and fixed to a portion of the stretchable lanyard body and not fixed at an opposite end wherein the biasing indicator strap is folded upon itself before a falling tool arresting event with sufficient force has occurred and biased away from itself after a falling tool arresting event with sufficient force has occurred.

5. The stretchable lanyard of claim 2 wherein the at least one stress indicium is a mark disposed on or embedded into an indicator strap wherein the indicator strap is fixed on one end to a predefined length of shrink tubing surrounding and fixed to a portion of the stretchable lanyard body adjacent to but spaced from the respective one of the lanyard tool attaching end portion and the lanyard anchoring end portion and on an opposite end to a corresponding one of the lanyard tool attaching end portion and the lanyard anchor attaching end portion wherein the mark is captured by the shrink tubing before a falling tool event has occurred and released by the shrink tubing after a falling tool event has occurred.

6. The stretchable lanyard of claim 4 wherein the predefined length of shrink tubing is an adhesive shrink tubing.

7. The stretchable lanyard of claim 5 wherein the predefined length of shrink tubing is an adhesive shrink tubing.

8. The stretchable lanyard of claim 3 wherein the outer tubing is one of opaque, translucent or transparent.

9. The stretchable lanyard of claim 4 wherein the predefined length of shrink tubing is one of opaque, translucent or transparent.

10. A method of determining when a stretchable lanyard has experienced a falling tool event, the method comprising:
obtaining a stretchable lanyard having a stressed lanyard indicator assembly connected to the stretchable lanyard adjacent to at least one of a lanyard tool attaching end portion or a lanyard anchoring end portion;
looking at the stressed lanyard indicator assembly; and
determining whether at least one stress indicium has changed from one of (1) a non-triggered position to a triggered position or (2) a non-visual position to a visual position wherein the at least one stress indicium indicates whether a falling tool arresting event with sufficient force has occurred.

11. A method of making a stretchable lanyard with a stress indicator, the method comprising:
obtaining a stretchable lanyard having a lanyard tool attaching end portion, a lanyard anchoring end portion and a stretchable lanyard body disposed between the lanyard tool attaching end portion and the lanyard anchoring end portion; and
attaching a stressed lanyard indicator assembly adjacent to at least one of the lanyard tool attaching end portion or the lanyard anchoring end portion and extends over a portion of the stretchable lanyard body wherein the stressed lanyard indicator assembly indicates when a falling tool arresting event with sufficient force has occurred.

12. The method of claim 11 wherein the attaching step includes providing at least one stress indicium that changes when a falling tool arresting event with sufficient force has occurred from one of (1) a non-triggered position to a triggered position or (2) a non-visual position to a visual position.

13. The method of claim 12 wherein the attaching step includes providing a predefined length of outer tubing and surrounding a portion of the stretchable lanyard body wherein the predefined length of outer tubing is fixed on one end to one of a respective one of the lanyard tool attaching end portion and the lanyard anchoring end portion and, on an opposite end, not fixed to the stretchable lanyard body wherein the at least one stress indicium is between the outer tubing and the portion of the stretchable lanyard body before a falling tool arresting event has occurred.

14. The method of claim 12 wherein the providing step includes selecting the at least one stress indicium from (1) a mark disposed on or embedded into the stretchable lanyard body, (2) a predefined length of shrink tubing surrounding and fixed to a portion of the stretchable lanyard body and (3) a biasing indicator strap wherein the biasing indicator strap is fixed on one end between a predefined length of shrink tubing surrounding and fixed to a portion of the stretchable lanyard body and not fixed at an opposite end wherein the biasing indicator strap is folded upon itself before a falling tool arresting event has occurred and biased away from itself after a falling tool arresting event has occurred.

15. The method of claim 12 wherein the providing step includes selecting the at least one stress indicium that is a mark disposed on or embedded into an indicator strap wherein the indicator strap is fixed on one end to a predefined length of shrink tubing surrounding and fixed to a portion of the stretchable lanyard body adjacent to but spaced from the respective one of the lanyard tool attaching end portion and the lanyard anchoring end portion and on an opposite end to a corresponding one of the lanyard tool attaching end portion and the lanyard anchor attaching end portion wherein the mark is captured by the shrink tubing before a falling tool event has occurred and released by the shrink tubing after a falling tool event has occurred.
